(19) United States
(12) Patent Application Publication
(10) Pub. No.: US 2015/0242147 A1
(43) Pub. Date: Aug. 27, 2015

(54) STORAGE MANAGEMENT APPARATUS, STORAGE APPARATUS, AND COMPUTER READABLE STORAGE MEDIUM

(71) Applicant: FUJITSU LIMITED, Kawasaki-shi (JP)

(72) Inventor: Akiko Sakaguchi, Yokohama (JP)

(21) Appl. No.: 14/612,436

(22) Filed: Feb. 3, 2015

(30) Foreign Application Priority Data
Feb. 26, 2014 (JP) 2014-035550

(51) Int. Cl. G06F 3/06

(52) U.S. Cl. CPC G06F 3/0619; G06F 3/065; G06F 3/067; G06F 3/0665

(57) ABSTRACT

A storage management apparatus is provided, including: a receiving unit that receives a copy command instructing a storage apparatus to copy data in a source volume among a plurality of volumes created to the storage apparatus, to a destination volume; a determination unit that obtains, from the storage apparatus, information on a configuration of the source volume specified in the copy command, determines a property for creating the destination volume based on the obtained information on the configuration of the source volume, and instructs the storage apparatus to create the destination volume; and a copy instructing unit that instructs a copy of the data in the source volume, into the destination volume that is created.

### CROSS-REFERENCE TO RELATED APPLICATION

This application is based upon and claims the benefit of priority of the prior Japanese Patent application No. 2014-035550, filed on Feb. 26, 2014, the entire contents of which are incorporated herein by reference.

### FIELD

The present disclosure relates to a storage management apparatus, a storage apparatus, and a non-transitory computer readable storage medium having a storage management program stored therein.

### BACKGROUND

A data backup is one of frequently- and widely-used techniques in information processing systems, storage apparatus.

Various kinds of backup software are typically used for such a data backup.

FIG. 13 is a diagram schematically illustrating a conventional information processing system 101.

The information processing system 101 includes a VM management server (operation server) 108, a backup server 102, a storage apparatus 103, and a tape apparatus 107.

The VM management server 108, the backup server 102, the storage apparatus 103, and the tape apparatus 107 are connected to each other through a local area network (LAN), for example.

The operation server 108 is a computer having a capability of functioning as a server, for example, and includes a CPU and a memory (which are not illustrated). The operation server 108 executes operating software 111 used for operations in the information processing system 101 and reads and writes data to and from storage areas provided by the storage apparatus 103 (described later), by sending a disk access command, such as a read or write command, to the storage apparatus 103.

The storage apparatus 103 provides the operation server 108 with storage areas, and is communicatively connected to the operation server 108 through the LAN.

The storage apparatus 103 includes physical disks (storage devices) 104-106. The physical the disks 104-106 may also be referred to as the disks 104-106.

The disks 104-106 are physical disks, and may be solid state drives (SSDs) or serial-attached SCSI (Small Computer Systems Interface) (SAS) disks, for example. Each of the disks 104-106 belongs to one of multiple Redundant Arrays of Inexpensive Disks (RAID) groups, and the different RAID group have different RAID levels.

The backup server 102 is an information processing apparatus that is used for a data backup in the storage apparatus 103, and includes a CPU and a memory (which are not illustrated). The backup server 102 includes a control storage managing unit 113 for controlling the storage apparatus 103, and is executing the backup software 112.

The backup software 112 controls the storage apparatus 103 via the storage managing unit 113, and instructs the storage apparatus 103 to execute a data backup in the storage apparatus 103.

Specifically, the backup software 112 instructs the storage apparatus 103 to create a destination volume 152, to which data in an operating (source) volume 151 in the storage apparatus 103 is to be copied. The backup software 112 creates a destination volume 152, provided that the storage apparatus 103 has a free physical storage area of the same size as that of source volume 151, and is unused.

The backup software 112 copies data in the source volume 151 into the destination volume 152. The data copied into destination volume 152 is identical to the data at the time when the backup was initiated by the backup software 112, and will not be used for operations by the VM management server 108.

The backup software 112 then writes the data which has been copied into destination volume 152 into the tape apparatus 107, as the backup data 153. Once the backup data 153 is written into the tape apparatus 107, the backup software 112 deletes the destination volume 152 from the storage apparatus 103.

In a configuration of such a conventional technique, the destination volume 152 and is not used for operations in the system 101, and is deleted after the copy to the tape apparatus 107 is done.

Further, as described above, the backup software 112 can create a destination volume 152, only when the storage apparatus 103 has a free physical storage area of the same size as that of source volume 151.

When the storage apparatus 103 does not have any free physical storage area of the same size as that of source volume 151, a system administrator or any other users of the information processing system 101 have to manually create a destination volume 152 and delete it after a copy is done. These tasks are burdensome, particularly when the storage apparatus 103 has numerous physical disks or when data is copied frequently.

### SUMMARY

Accordingly, a storage management apparatus is provided, including: a receiving unit that receives a copy command instructing a storage apparatus to copy data in a source volume among a plurality of volumes created to the storage apparatus, to a destination volume; a determination unit that obtains, from the storage apparatus, information on a configuration of the source volume specified in the copy command, determines a property for creating the destination volume based on the obtained information on the configuration of the source volume, and instructs the storage apparatus to create the destination volume; and a copy instructing unit that instructs a copy of the data in the source volume, into the destination volume that is created.

Furthermore, a storage apparatus is provided including: at least one storage device that includes a storage region capable of storing data; a configuration managing unit that creates a part of the storage region in the at least one storage device, as a plurality of volumes; a receiving unit that receives, from a host apparatus, a copy command instructing a copy of data in a source volume among the created plurality of volumes, to a destination volume; a determination unit that obtains, from the configuration managing unit, information on a configuration of the source volume specified in the copy command, determines a property for creating the destination volume based on the obtained information on the configuration of the source volume, and instructs the configuration managing unit to create the destination volume; and a copy unit that copies the data in the source volume, into the destination volume that is created.

Furthermore, a non-transitory computer readable storage medium having a storage management program stored therein is provided, the storage management program causing a computer to: receive a copy command instructing a storage apparatus to copy data in a source volume among a plurality of volumes created to the storage apparatus, to a destination volume; obtain, from the storage apparatus, information on a configuration of the source volume specified in the copy command, determine a property for creating the destination volume based on the obtained information on the configuration of the source volume, and instruct the storage apparatus to create the destination volume; and instruct a copy of the data in the source volume, into the destination volume that is created.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration of an information processing system as an example of one embodiment;

FIG. 2 is a diagram illustrating a functional configuration of the information processing system as an example of one embodiment;

FIG. 3 is a diagram illustrating an example of an allowed RAID table as an example of one embodiment;

FIG. 4 is a diagram illustrating an example of a physical disk priority table as an example of one embodiment;

FIG. 5 is a diagram illustrating an example of a RAID level priority table as an example of one embodiment;

FIG. 6 is a diagram illustrating an example of a RAID selection table as an example of one embodiment;

FIG. 7 is a flowchart illustrating a copy in the information processing system as an example of one embodiment;

FIG. 8 is a flowchart illustrating a volume selection by a volume determination unit as an example of one embodiment;

FIG. 9 is a diagram illustrating an overall configuration of an information processing system as a first modification to an embodiment;

FIG. 10 is a diagram illustrating a functional configuration of the information processing system as the first modification to an embodiment;

FIG. 11 is a diagram illustrating an overall configuration of an information processing system as a second modification to an embodiment;

FIG. 12 is a diagram illustrating a functional configuration of the information processing system as the second modification to an embodiment; and

FIG. 13 is a diagram schematically illustrating conventional information processing system.

### DESCRIPTION OF THE PREFERRED EMBODIMENTS

A management apparatus, a storage apparatus, and a storage management program, as an example of the present embodiment, will be described with reference to the drawings.

Note that the embodiments discussed herein are merely exemplary, and it is not intended that various modifications and applications of the teachings not explicitly described are not omitted. In other words, the embodiments may be modified, within the scope of the spirit of the embodiments (such as combinations of embodiments and modifications).

(A) Configuration

A configuration of an information processing system 1 as an example of one embodiment will be described.

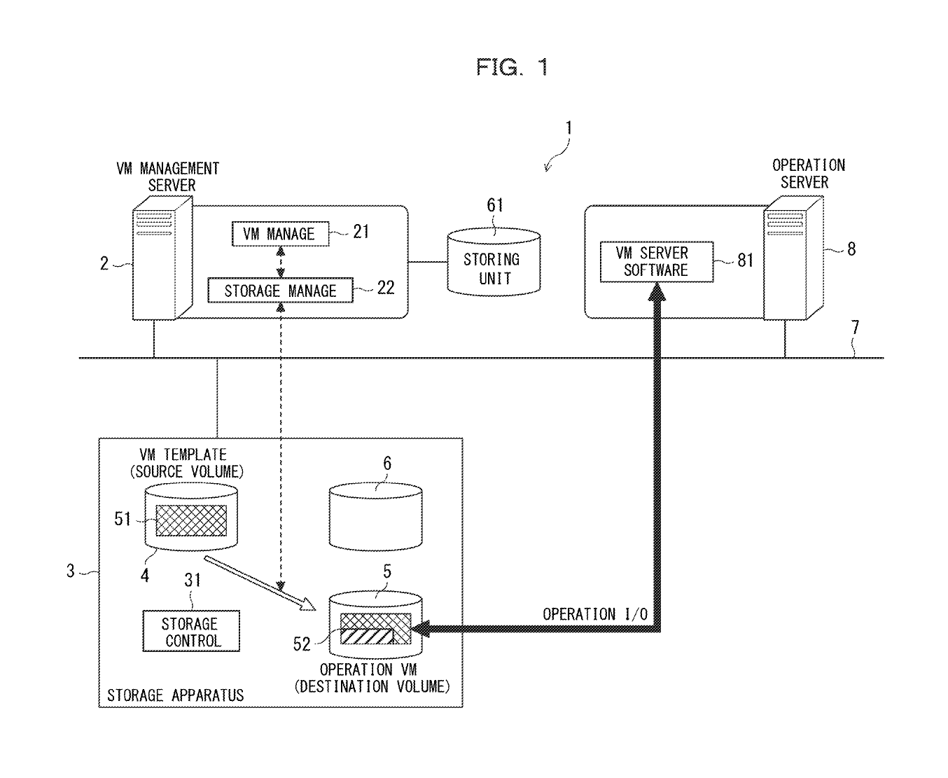

FIG. 1 is a diagram illustrating an overall configuration of the information processing system 1 as an example of one embodiment.

The information processing system 1 includes a virtual machine (VM) management server (host apparatus) 2, an operation server 8, and a storage apparatus 3.

The VM management server 2, the operation server 8, and the storage apparatus 3 are connected to each other through a LAN 7, for example.

The VM management server 2 is a server that provides a virtual environment in the information processing system 1, and includes a VM management unit 21 and a storage managing unit (storage management apparatus) 22. The VM management server 2 also includes a storing unit 61 that stores data for various kinds of processing in the VM management server 2. The storing unit 61 is a hard disk drive (HDD) or an SSD, for example.

The VM management unit 21 is software that executes various kinds of virtualization processes, in order to provide a virtual environment in the information processing system 1. Any known virtualization management software may be used as the VM management unit 21.

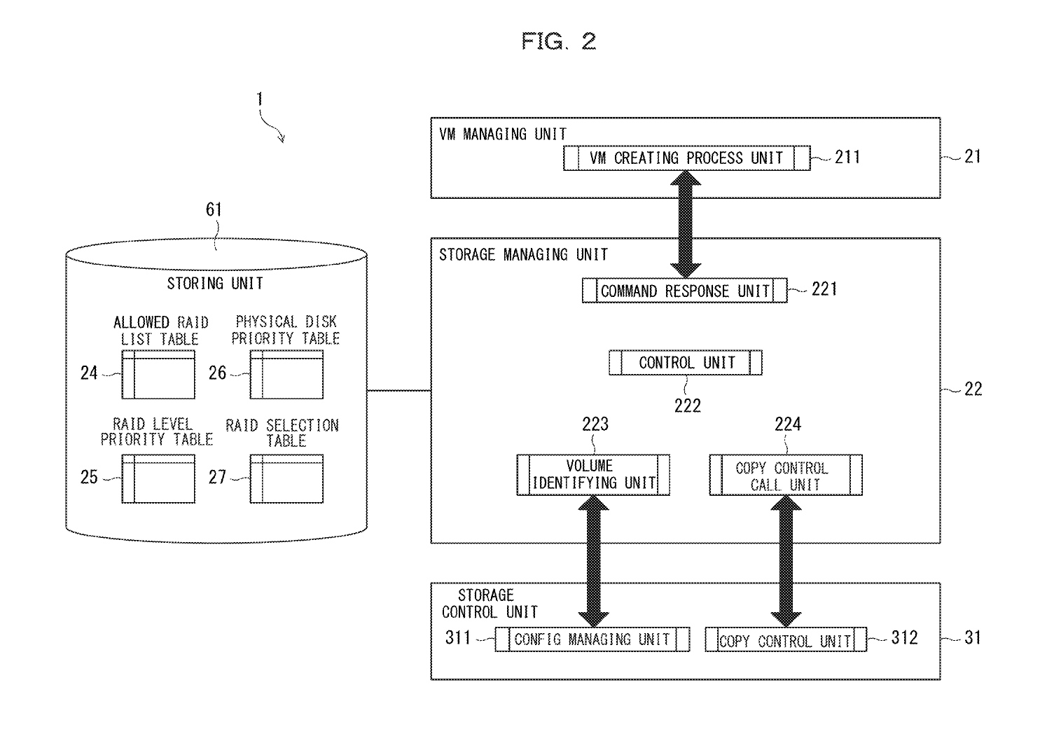

The storage managing unit 22 controls the storage apparatus 3 (described later) in the virtual environment. The detailed functions and configuration of the storage managing unit 22 will be described later with reference to FIG. 2.

The operation server 8 is a computer having a capability of functioning as a server, for example, and includes a CPU and a memory (which are not illustrated). The operation server 8 executes VM server software 81 used for operations in the information processing system 1, and reads and writes data to and from storage areas provided by the storage apparatus 3, by sending a disk access command (I/O commands), such as a read or write command, to the storage apparatus 3.

The storage apparatus 3 provides the operation server 8 with storage areas, and is communicatively connected to the operation server 8 through the LAN 7. In the present embodiment, the storage apparatus 3 is a virtual storage apparatus.

The storage apparatus 3 includes physical disks (storage devices) 4-6 and a storage controlling unit 31. The physical the disks 4-6 may also be referred to as the disks 4-6.

The disks 4-6 are physical disks, and may be SSDs or SAS disks, for example. In the storage apparatus 3, volumes (also referred to as “logical units” or “LUNs”) are created using the disks 4-6, and are provided to the operation server 8. Each of the disks 4-1 belongs to one of multiple RAID groups, and the different RAID group have different RAID levels.

In an example of the present embodiment, the storage apparatus 3 includes the plurality of disks 4-6, and functions as a virtualization storage apparatus that creates volumes using the disks 4-6.

FIG. 2 is a diagram illustrating a functional configuration of the information processing system 1 as an example of one embodiment.

The VM management unit 21 in the VM management server 2 includes a VM creating processing unit 211.

The VM creating processing unit 211 creates a VM. The detailed functions of the VM creating processing unit 211 are the same as those used in well-known typical VM systems, and their descriptions are omitted.

The storage managing unit 22 in the VM management server 2 receives a storage control command, from the VM management unit 21. In the present embodiment, when a user of the information processing system 1 executes a copy command without supplying a parameter for specifying a destination volume, the storage managing unit 22 instructs a configuration managing unit 311 (described later) in the storage controlling unit 31, to create a new destination volume. In such a case, the storage managing unit 22 instructs creation of a destination volume 52 (see FIG. 1) such that properties (such as the RAID level of the RAID group, and the disk type of a physical disk) of the destination volume 52 match the properties of a source volume 51 (see FIG. 1), as closely as possible.

As used herein, the expression “the properties of the destination volume 52 match the properties of a source volume 51 as closely as possible” means that at least one of the RAID level and the disk type of a physical disk of a RAID group, in which a destination volume 52 is to be created, are similar to or are the same as the RAID level and the disk type of the RAID group where the source volume 51 has been created, for example. The degree of the match between the RAID levels and disk types of RAID groups is determined from a RAID level priority table 25 and a physical disk priority table 26, which will be described later.

The storage managing unit 22 includes a command response unit (receiving unit) 221, a control unit 222, a volume identifying unit (determination unit) 223, and a copy control calling unit (copy instructing unit) 224. The storing unit 61 stores an allowed RAID table 24, a RAID level priority table 25, a physical disk priority table 26, and a RAID selection table 27.

The command response unit 221 sends and receives commands to and from the VM creating processing unit 211 in the VM management unit 21. For example, the command response unit 221 receives a VM creation command or a copy command from the VM creating processing unit 211 in the VM management unit 21, and sends the command to a control unit 222 (described later). In response to receiving a response (e.g., results of a command that was executed) addressed to the VM creating processing unit 211, from the control unit 222, the command response unit 221 sends it to the VM creating processing unit 211.

The control unit 222 performs various kinds of controls on the storage apparatus 3, in the virtual environment. In the present embodiment, in response to receiving a copy command from a user using the operation server 8, via the command response unit 221, the control unit 222 instructs the volume identifying unit 223 create a new destination volume 52. The user executes a copy command by supplying a source volume 51 and a copy type, as mandatory parameters for the copy command.

For example, as a parameter specifying the source volume 51, any type of information (e.g., a volume ID) that uniquely identifies a source volume 51 in the storage apparatus 3 can be supplied.

The parameter of the copy type may be set to a mirror (e.g., Equivalent Copy (EC)) for creating a full copy of data in a source volume 51, and a snap shot (e.g., SnapOPC or SnapOPC+) for a differential backup of data in a certain volume, for example. Alternatively, a clone (e.g., OPC or QuickOPC) for copying from a source volume to a destination volume, may also be specified. Herein, the term “OPC” stands for One Point Copy.

The destination volume 52 is an optional parameter for the copy command, meaning that it is not mandatory in an example of the present embodiment, since the volume identifying unit 223 identifies an appropriate RAID group for creating a destination volume 52 if no parameter is specified.

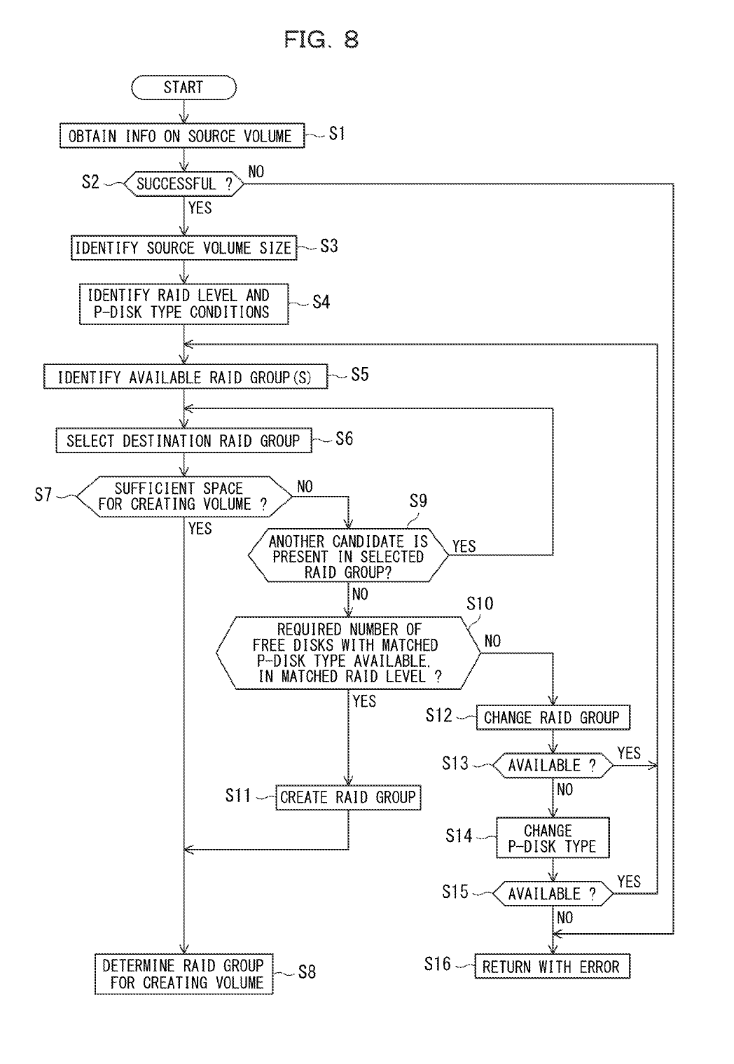

When no parameter for a destination volume 52 is specified in a copy command, the volume identifying unit 223 executes a volume selection to identify an appropriate RAID group, in which a destination volume 52 is to be created. The volume identifying unit 223 then instructs a configuration managing unit 311 (described later) in the storage controlling unit 31, to create a new destination volume 52 in the identified RAID group. A volume selection by the volume identifying unit 223 will be described later with reference to FIG. 8.

The copy control calling unit 224 instructs a copy control unit 312 (described later) in the storage controlling unit 31 in the storage apparatus 3, to execute a copy.

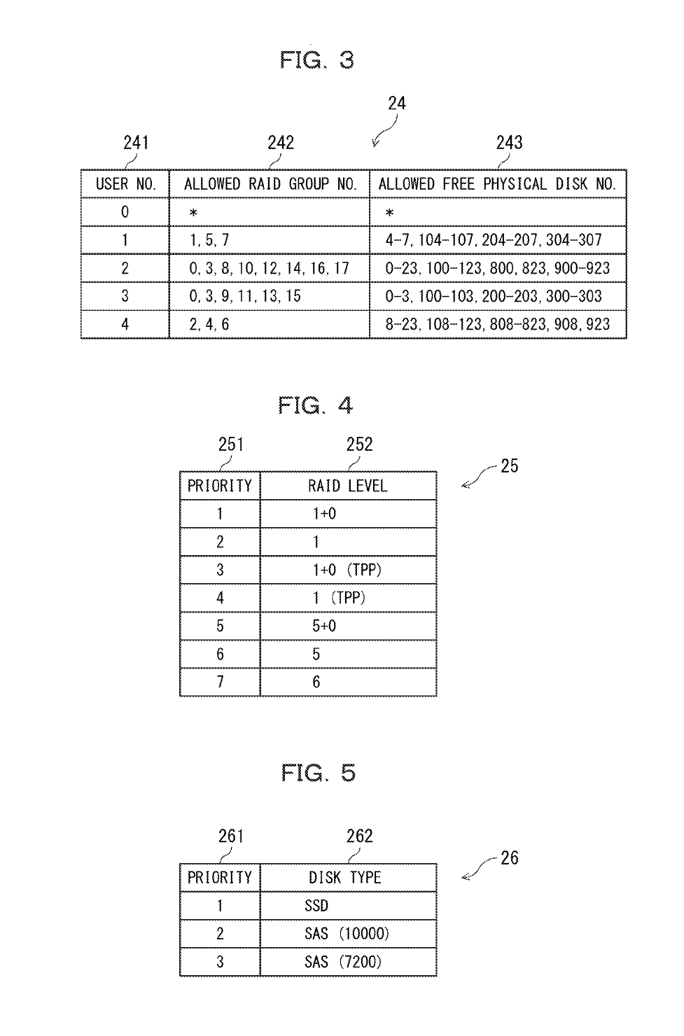

The allowed RAID table 24 is a table for maintaining information on RAID groups and physical disks which are allowed for respective users of the information processing system 1. The allowed RAID table 24 will be described later with reference to FIG. 3.

The RAID level priority table 25 contains information defining priorities among RAID levels for a selection of a RAID group by the volume identifying unit 223, if no RAID group is available for creating a destination volume 52, among RAID groups in the same RAID level as that of the source volume 51, during a volume selection by the volume identifying unit 223. Specifically, if no RAID group is available for creating a destination volume 52, the volume identifying unit 223 looks up the RAID level priority table 25, and adjusts a RAID level property for selecting a RAID group. The RAID level priority table 25 will be described later with reference to FIG. 4.

The physical disk priority table 26 contains information defining priorities among physical disk types for a selection of a RAID group by the volume identifying unit 223, if no RAID group is still available for creating a destination volume 52 even after the RAID level property was adjusted during the volume selection by the volume identifying unit 223. Specifically, if no RAID group is available for creating a destination volume 52 even after the RAID level property was adjusted, the volume identifying unit 223 looks up the physical disk priority table 26, and adjusts the disk type property for selecting a RAID group. The physical disk priority table 26 will be described later with reference to FIG. 5.

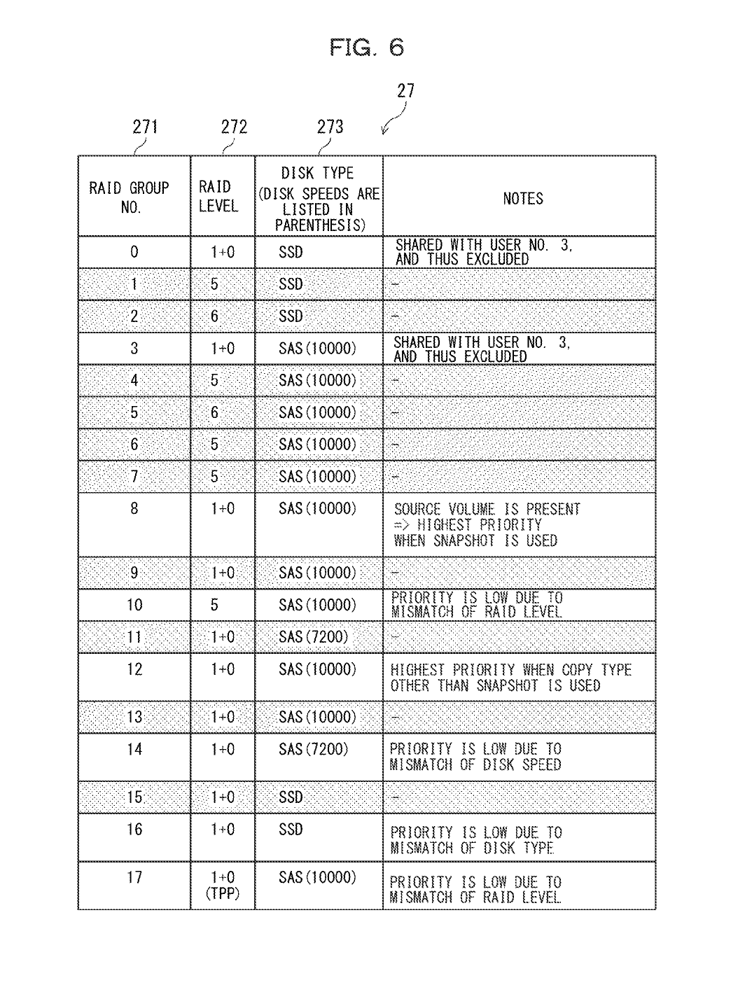

The RAID selection table 27 is temporary information indicating the RAID level and the physical disk types for each RAID group, and is used by the volume identifying unit 223 during the volume selection. The RAID selection table 27 will be described later with reference to FIG. 6.

The storage controlling unit 31 in the storage apparatus 3 controls the storage apparatus 3. The storage controlling unit 31 includes a configuration managing unit 311 and a copy control unit 312.

The configuration managing unit 311 creates and configures volumes (LUNs) and RAID groups in the storage apparatus 3. LUNs and RAID groups can be created and configured by the configuration managing unit 311 using well-known techniques, and detailed description therefor will be omitted.

The copy control unit 312 executes a data copy between volumes in the storage apparatus 3.

FIG. 3 is a diagram illustrating an example of the allowed RAID table 24 as an example of one embodiment.

The allowed RAID table 24 includes fields of a user number (No.) 241, an allowed RAID group number (No.) 242, and an available free physical disk number (No.) 243.

The user number 241 stores identifiers that uniquely identify respective users of the information processing system 1. In the example in FIG. 3, the user number 241 stores numerical values indicating user IDs of the users.

The allowed RAID group number 242 stores numbers that identify RAID groups which can be used by respective users of the storage apparatus 3. For example, in the example in FIG. 3, the user of User No. 1 can use RAID groups of RAID group Nos. 1, 5, and 7. Note that a value of “*” is a wildcard, meaning that the user of User No. 0 is allowed to use all RAID groups in the storage apparatus 3.

The allowed free physical disk number 243 stores numbers that identify free physical disks in the RAID group which can be used by respective users of the storage apparatus 3. For example, in the example in FIG. 3, the user of User No. 1 can use physical disks specified by the numbers 4-7, 104-107, 204-207, and 304-307. Note that a value of “*” is a wildcard, meaning that the user of User No. 0 can use all free physical disks in the storage apparatus 3.

When the storage apparatus 3 does not have the capability of assigning corresponding RAID group(s) to each user, no allowed RAID table 24 is created. In such a case, the volume identifying unit 223 considers that a user is allowed to use all RAID groups during a volume selection.

FIG. 4 is a diagram illustrating an example of the RAID level priority table 25 as an example of one embodiment.

The RAID level priority table 25 includes a priority 251 and a RAID level 252.

The priority 251 stores values (e.g., integers of 1 or higher), indicating priorities of the RAID levels for a selection of a RAID group by the volume identifying unit 223, if no RAID group is available for creating a destination volume 52 in RAID groups in the same RAID level as that of the source volume 51 during a volume selection by the volume identifying unit 223. In the example in FIG. 4, a value of “1” indicates the highest priority, and the priorities reduce as the values decrease.

The RAID level 252 stores values indicating RAID levels. For example, in the example in FIG. 4, a value of “1+0” represents RAID 1+0; a value of “1” represents RAID 1; and a value of “1+0 (TPP)” represents RAID 1+0 in a thin provisioning pool (TPP). A value of “1 (TPP)” represents RAID 1 in a TPP; a value of “5+0” represents RAID 5+0; a value of “5” represents RAID 5; and a value of “6” represents RAID 6. Note that “TPP volumes” is variable-sized volumes created for reducing the physical capacities of the storage apparatus 3 as a whole.

The priorities in the RAID level priority table 25 may be set in advance by a system administrator or other users, based on how the information processing system 1 is being operated (e.g., the redundancy required for the system).

Upon selecting a RAID level in a volume selection, the volume identifying unit 223 looks up the RAID level priority table 25, and tries to select a RAID level matching the RAID level of the source volume 51. If there is no match, the next lower priority is tried and so on. When the lowest-priority RAID level is reached in the RAID level priority table 25, the volume identifying unit 223 continues to select another RAID level, starting from the RAID level with the highest priority. If there is still no match, the next lower priority is tried and so on.

FIG. 5 is a diagram illustrating an example of the physical disk priority table 26 as an example of one embodiment.

The physical disk priority table 26 includes a priority 261 and a disk type 262.

The priority 261 stores values (e.g., integers of 1 or higher), indicating priorities of the disk types for a selection of a RAID group by the volume identifying unit 223, if no RAID group is available for creating a destination volume 52 even after the RAID level property was adjusted, during the volume selection by the volume identifying unit 223. In the example in FIG. 5, a value of “1” indicates the highest priority, and the priorities reduce as the values decrease.

The disk type 262 stores values indicating physical disk types. For example, in the example depicted in FIG. 5, a value of “SSD” represents an SSD; a value of “SAS (disk rotation speed)” represents a SAS disk, together with the rotation speeds indicating performance of that particular SAS disk in parenthesis.

The priorities in the physical disk priority table 26 may be set in advance by a system administrator or other users, based on how the information processing system 1 is being operated (e.g., the redundancy required for the system).

Upon selecting a physical disk in the volume selection, the volume identifying unit 223 tries to select a disk type matching the disk type of the source volume 51. If there is no match, the next lower priority is tried and so on. When the lowest-priority disk type is reached in the physical disk priority table 26, the volume identifying unit 223 continues to select another disk type, starting from the disk type with the highest priority. If there is still no match, the next lower priority is tried and so on.

FIG. 6 is a diagram illustrating an example of the RAID selection table 27 as an example of one embodiment.

The RAID selection table 27 includes a RAID group number 271, a RAID level 272, and a disk type 273. In the example illustrated in FIG. 6, the “Note” column is appended, for the sake of illustration.

The RAID group number 271 stores numbers that identify RAID groups that are present in the storage apparatus 3.

The RAID level 272 stores a value indicating the RAID level of the RAID group indicated by the RAID group number 271. In the example in FIG. 6, a value of “1+0” represents RAID 1+0; a value of “1” represents RAID 1; a value of “1+0 (TPP)” represents RAID 1+0 in a TPP. A value of “1 (TPP)” represents RAID 1 in a TPP; a value of “5+0” represents RAID 5+0; a value of “5” represents RAID 5; and a value of “6” represents RAID 6.

The disk type 273 indicates types of physical disks present in the RAID group indicated by the RAID group number 271. For example, in the example depicted in FIG. 6, a value of “SSD” represents an SSD; a value of “SAS (disk rotation speed)” represents a SAS disk, together with the rotation speeds indicating performance of that particular SAS disk in parenthesis.

Note that a program (storage management program) for implementing the functions as the storage managing unit 22, the command response unit 221, the control unit 222, the volume identifying unit 223, and the copy control calling unit 224 described above, are provided in the form of programs recorded on a computer read able recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD), a Blu-ray disc, a magnetic disk, an optical disk, a magneto-optical disk, or the like. The computer then reads a program from that storage medium using a medium reader (not illustrated) and uses that program after transferring it to an internal storage apparatus or external storage apparatus or the like. Alternatively, the program may be recoded on a storage unit (storage medium), for example, a magnetic disk, an optical disk, a magneto-optical disk, or the like, and the program may be provided from the storage unit to the computer through a communication path.

Upon embodying the functions as the storage managing unit 22, the command response unit 221, the control unit 222, the volume identifying unit 223, and the copy control calling unit 224, the program (storage management program) stored in an internal storage apparatus (a memory (not illustrated) in the VM management server 2, in the present embodiment) is executed by a microprocessor of the computer (a CPU (not illustrated) in the VM management server 2, in the present embodiment). In this case, the computer may alternatively read a program stored in a storage medium for executing it.

Further, a program (storage management program) for implementing the storage controlling unit 31, the configuration managing unit 311, and the copy control unit 312 described above, are provided in the form of programs recorded on a computer read able recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD), a Blu-ray disc, a magnetic disk, an optical disk, a magneto-optical disk, or the like. The computer then reads a program from that storage medium using a medium reader (not illustrated) and uses that program after transferring it to an internal storage apparatus or external storage apparatus or the like. Alternatively, the program may be recoded on a storage unit (storage medium), for example, a magnetic disk, an optical disk, a magneto-optical disk, or the like, and the program may be provided from the storage unit to the computer through a communication path.

Upon embodying the functions as the storage controlling unit 31, the configuration managing unit 311, and the copy control unit 312, the program (storage management program) stored in an internal storage apparatus (a memory (not illustrated) in a control module (CM) (not illustrated) in the storage apparatus 3, in the present embodiment) is executed by a microprocessor of the computer (a CPU (not illustrated) in the CM (not illustrated) in the storage apparatus 3, in the present embodiment). In this case, the computer may alternatively read a program stored in a storage medium for executing it.

(B) Operations

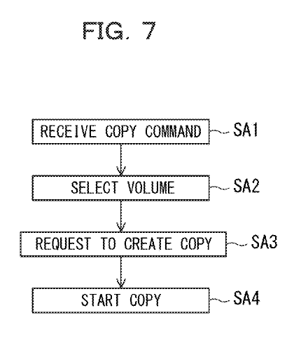

Hereinafter, a copy in the information processing system 1 will be described with reference to FIGS. 7-8.

FIG. 7 is a flowchart (Steps SA1 to SA4) illustrating a copy in the information processing system 1 as an example of one embodiment.

In Step SA1, the command response unit 221 in the storage managing unit 22 receives a copy command, from a user employing the operation server 8, via the VM creating processing unit 211 in the VM management unit 21.

In this example, a source volume 51 and a copy type have been specified as parameters for the copy command, but no parameter for a destination volume 52 has been specified.

Next, in Step SA2, the volume identifying unit 223 in the storage managing unit 22 executes a volume selection, to select an existing RAID group or create a new one, as a RAID group, in which a destination volume 52 is to be created. This selection will be described later with reference to FIG. 8.

Next, in Step SA3, the volume identifying unit 223 instructs the configuration managing unit 311 in the storage apparatus 3, to create a destination volume in the RAID group selected in Step SA2, for creating a destination volume 52.

After the destination volume is created, in Step SA4, the copy control calling unit 224 checks that a copy can be made in the destination volume 52, and instructs the copy control unit 312 in the storage apparatus 3, to initiate a copy.

FIG. 8 is a flowchart (Steps S1 to S16) illustrating a volume selection by the volume identifying unit 223 as an example of one embodiment.

In Step S1, the volume identifying unit 223 obtains, from the configuration managing unit 311 in the storage apparatus 3, information on the source volume 51 specified in the copy command received in Step SA1 in FIG. 7. In this step, the volume identifying unit 223 obtains, the physical size of the source volume 51, and the RAID level and the disk type of the RAID group where the source volume 51 is present, for example, as the information on the source volume 51.

In Step S2, the volume identifying unit 223 determines whether or not information on the source volume 51 can be obtained from the configuration managing unit 311 in the storage apparatus 3 in Step S1.

If no information on the source volume 51 can be obtained (refer to the NO route from Step S2), in Step S16, the volume identifying unit 223 terminates this flow in an error (returns with an error), notifying that a copy from a non-existing source volume 51 was instructed.

Otherwise, if information on the source volume 51 can be obtained (refer to the YES route from Step S2), in Step S3, the volume identifying unit 223 determines the size (capacity) required for a destination volume 52, based on the size determined in Step S3 and the copy type specified in Step SA1 in FIG. 7.

For example, if the copy type is a clone or a mirror, a destination volume 52 is required to have the size the same as that of the source volume 51. If the copy type is snap shot, a destination virtual volume does not have to be in the same size as that of the source volume 51 (on other words, the actual size of a destination volume 52 that is to be created initially may be smaller than the size of the source volume 51).

Next, in Step S4, the volume identifying unit 223 determines the properties (a RAID level and a disk type) of a RAID group, in which a destination volume 52 is to be created,

Specifically, the volume identifying unit 223 sets initial values for the RAID level and the disk type of the destination volume 52, to the values of the RAID level and the disk type of the physical disk of the source volume 51, respectively.

Next, in Step S5, the volume identifying unit 223 creates a list of RAID groups that are allowed to the user who executed the copy command (command originator), by looking up the allowed RAID table 24 (see FIG. 3).

For example, in the example in FIG. 3, when the user of User No. 2 is an originator of a command, the volume identifying unit 223 selects RAID groups Nos. 0, 3, 8, 10, 12, 14, 16, and 17, as allowed RAID groups.

When the storage apparatus 3 does not have the capability of assigning corresponding RAID group(s) to each user, no allowed RAID table 24 has been created and hence the volume identifying unit 223 considers that command originator is allowed to use all RAID groups.

In Step S6, the volume identifying unit 223 creates a RAID selection table 27 (see FIG. 6), and selects all RAID groups that are allowed to the command originator and have matches in the RAID level and disk type properties determined in Step S4, among the RAID groups that have been created in the storage apparatus 3.

In this step, when the copy type parameter specified in the copy command received in Step SA1 in FIG. 7 is a differential copy, the volume identifying unit 223 selects a RAID group where the source volume 51 is present. This is because a differential copy of a volume is typically made within a single RAID group.

Otherwise, if the copy type parameter is full copy, the volume identifying unit 223 selects one RAID group other than the RAID group where the source volume 51 is present, among the RAID groups selected in Step S5. This is because a full copy of a volume is typically made across RAID groups, for the purpose of a replacement or a maintenance of the storage apparatus 3, for example.

If no RAID group has matches in the properties, the volume identifying unit 223 selects a RAID group having properties which have closest matches to the properties of the RAID level and the disk type, which were determined in Step S4. In this step, the volume identifying unit 223 makes this selection using the RAID level priority table 25 and the physical disk priority table 26.

The volume identifying unit 223 eliminates any RAID groups shared by multiple users, when the storage apparatus 3 has a capability to specify which user can use which RAID groups.

As an example, the user of User No. 2 tries to copy a volume present in RAID group No. 8, in the example in FIG. 6. In Step S5, the volume identifying unit 223 selects RAID group Nos. 0, 3, 8, 10, 12, 14, 16, and 17, as allowed RAID groups. Among these allowed RAID groups, RAID group Nos. 3, No. 8, No. 12 have properties that match the properties of the RAID level and the physical disk (i.e., the RAID level of “1+0” and the disk type of “SAS (10000)”) of the source volume 51. Referring to the allowed RAID table 24 in FIG. 3, however, since the user of User No. 3 is also allowed to use RAID group No. 3 and hence the volume identifying unit 223 eliminates RAID group No. 3 from the list of candidate RAID groups for creating a destination volume 52.

The volume identifying unit 223 then selects RAID group No. 8 when the copy type is a differential copy (snap shot), or selects RAID group No. 12 otherwise (other copy types), as a RAID group, in which a destination volume 52 is to be created.

In Step S7, the volume identifying unit 223 determines whether or not a volume having the size determined in Step S3 can be created in the RAID group selected in Step S6. For example, the volume identifying unit 223 determines that a new destination volume 52 can be created if the free disk size available in the RAID group selected in Step S6 is equal to or greater than the physical size of the source volume 51 obtained in Step S1.

If the destination volume 52 can be created (refer to the YES route from Step S7), in Step S8, the volume identifying unit 223 selects the RAID group selected in Step S6, as a RAID group for creating a destination volume 52, and terminates this flow.

Otherwise, if the destination volume 52 cannot be created (refer to the NO route from Step S7), in Step S9, the volume identifying unit 223 determines whether or not there is any RAID group, which can be selected as a candidate for creating a destination volume 52, other than the RAID groups selected in Step S6, among the RAID groups selected in Step S3.

If there is another candidate (refer to the YES route from Step S9), the flow returns to Step S6. The volume identifying unit 223 then selects, among the RAID groups selected in Step S5, a RAID group having the closest matches with the RAID level and the disk type determined in Step S4, and executes the steps starting from Step S7.

Otherwise, If there is no other candidate (refer to the NO route from Step S9), among the RAID groups selected in Step S5, no destination volume can be created in any of the existing RAID groups having the RAID level and the disk type matching to those of the source volume 51.

Thus, in Step S10, the volume identifying unit 223 determines whether or not a new RAID group having the same RAID level as that of the source volume 51 can be created using a physical disk having the same disk type as that of the source volume 51, among unused disks which are allowed to the command originator.

In this step, the volume identifying unit 223 checks whether or not there are the required number of free physical disks having the matched RAID group and disk type are present in that RAID level. If there are the required number of disks, no RAID group can be created. Note that the number of free physical disks required varies depending on the RAID level. For example, two free physical disks are required for RAID level 1.

If a RAID group can be created (refer to the YES route from Step S10), in Step S11, the volume identifying unit 223 creates a new RAID group in the RAID level with the matched property and executes Step S8 described above. In Step S8, the RAID group created in Step S11 is selected as a RAID group for a destination volume 52.

Otherwise, if no RAID group can be created (refer to the NO route from Step S10), the volume identifying unit 223 tries to select another RAID group having a source volume 51 and/or a different RAID level. Specifically, in Step S12, the volume identifying unit 223 adjusts the RAID group property for selecting a RAID group, to a RAID level that has a lower priority than the RAID group of the source volume 51. In this step, the volume identifying unit 223 selects the RAID group property by looking up the RAID level priority table 25 (see FIG. 4).

Next, in Step S13, the volume identifying unit 223 determines whether or not a RAID group a RAID group can be selected, which matches the RAID level property adjusted in Step S12, can be selected, among RAID groups matching to the disk type property of the source volume 51.

If a RAID group can be selected, which matches the RAID level property adjusted in Step S12 (refer to the YES route from Step S13), the flow returns to Step S5 described above to execute steps starting from Step S5, to identify a RAID group for creating a destination volume 52.

If no RAID group can be selected, which matches the RAID level property (refer to the NO route from Step S13), the volume identifying unit 223 adjusts the disk type property for selecting a RAID group, and tries to select a RAID group. Specifically, in Step S14, the volume identifying unit 223 looks up the physical disk priority table 26 (see FIG. 5), and selects a RAID group such that the disk type of a destination volume 52 matches the disk type of the RAID group for the source volume 51 as closely as possible.

Next, in Step S15, the volume identifying unit 223 determines whether or not a RAID group can be selected, which matches the disk type property adjusted in Step S14.

If a RAID group can be selected which matches the disk type property adjusted in Step S14 (refer to the YES route from Step S15), the flow returns to Step S5 described above to execute the steps starting from Step S5, to identify a RAID group for creating a destination volume 52.

If no RAID group can be selected which matches the disk type property adjusted in Step S14 (refer to the NO route from Step S15), in Step S16, the volume identifying unit 223 terminates this flow with an error (returns with an error), notifying that creation of a destination volume 52.

(C) Advantageous Effects

As described above, in accordance with an example of the present embodiment, in the information processing system 1, even when a copy command is issued without specifying a destination volume 52, the volume identifying unit 223 instructs to create a destination volume 52 in an appropriate disk in the storage apparatus 3 based on information on the source volume 51 and the copy type.

Accordingly, in a storage apparatus 3 in a virtual environment, data is copied to a destination which closely matches the properties of the source volume 51, solving the problem of the conventional techniques in that no copy can be executed since a destination specified does not match the properties for executing the copy.

Further, in an example of the present embodiment, the volume identifying unit 223 identifies a RAID group for creating a destination volume 52, based on the RAID group and the disk type of the source volume 51, without requiring any user interventions. Hence, this assures that a generated destination volume 52 has a redundancy and an access performance which match those of the source volume 51 and a performance as closely as possible, without requiring any user interventions.

Furthermore, the volume identifying unit 223 identifies a RAID group for creating a destination volume 52, based on the copy type (e.g., a full copy, or a differential copy) specified in the copy command, without requiring any user interventions. Accordingly, a destination volume 52 is created in a pool that is suitable for operation I/Os, without requiring any user interventions created.

Additionally, in an example of the present embodiment, the volume identifying unit 223 appropriately selects a RAID group for creating a destination volume 52, according to the copy type specified in the copy command (e.g., a full copy, or a differential copy). This ensures that a volume copy is executed in an appropriate RAID group, depending on how the storage apparatus 3 is operated.

One exemplary application for the volume copy as an example of the present embodiment is preparation of environments for a software development. In a conventional information processing system, multiple information processing apparatuses (machines) are required for a software development, and volume copies are required to be executed on all of the machines to construct development environments.

Otherwise, for preparing multiple virtual machines for a software development in the information processing system 1, data in an existing environment can be used as a template, and copied to the virtual machines in a differential copy. In this manner, virtual machines can be easily configured for multiple development projects. In such a case, an administrator of the information processing system 1 only has to specify a volume in the existing environment to be used as a template without requiring to specify destination volumes 52, which significantly reduces burden upon creating the destination volumes 52.

(D) Miscellaneous

Note that the present disclosure is not limited to the embodiments described above, and various modifications may be made without departing from the spirit of the present disclosure.

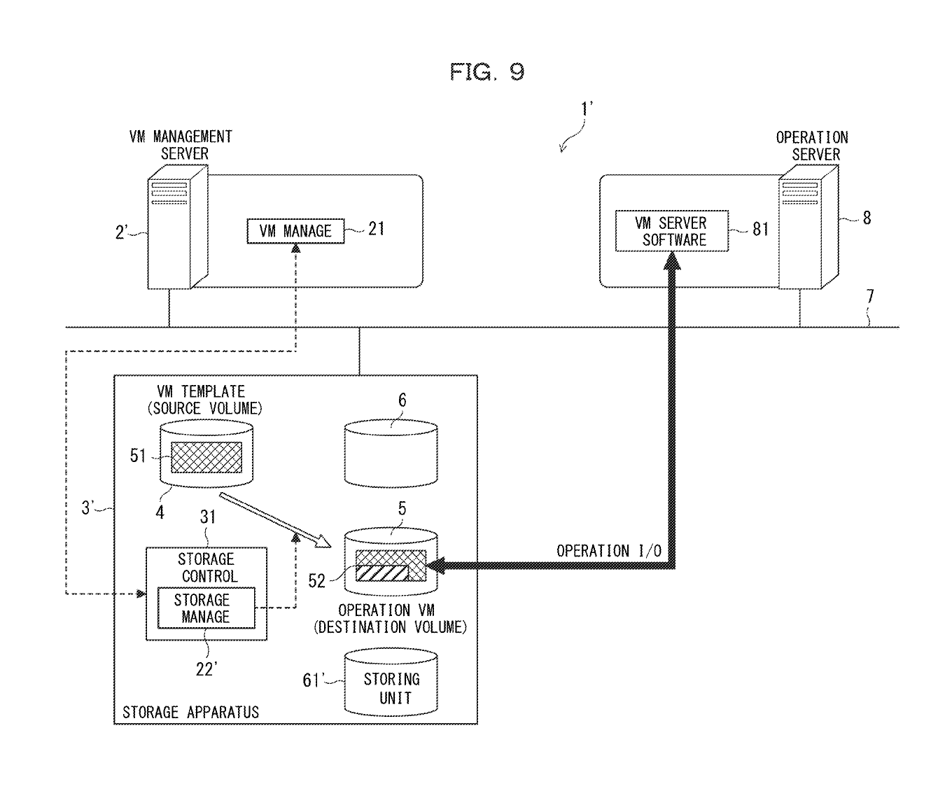

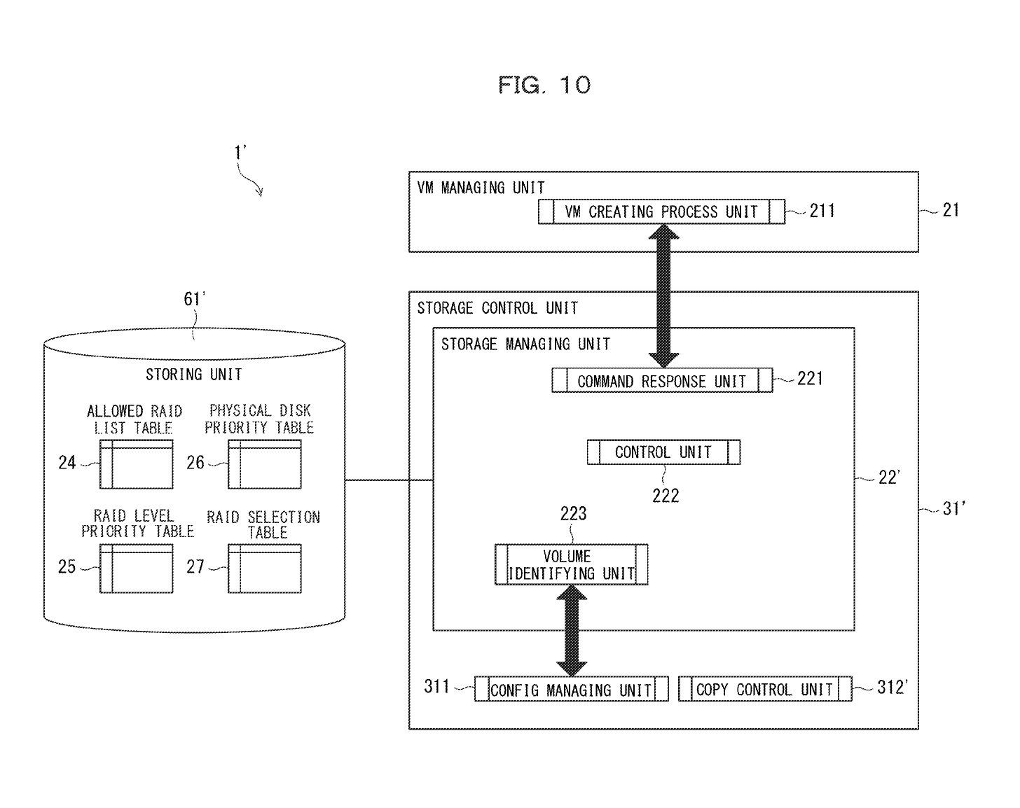

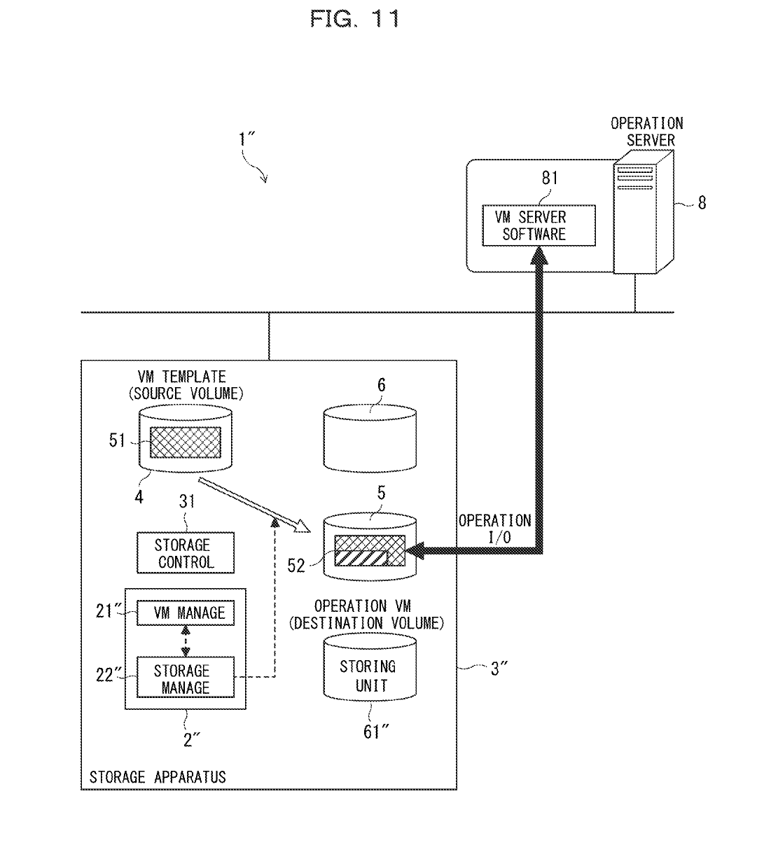

FIG. 9 is a diagram illustrating an overall configuration of an information processing system 1′ as a first modification to an embodiment and FIG. 10 is a diagram illustrating a functional configuration of the information processing system 1′ as in FIG. 9.

In example of the above-described embodiment illustrated in FIG. 2, the storage managing unit 22 is provided in the VM management server 2. In this information processing system 1′, however, a storage managing unit 22′ is provided in a storage controlling unit 31′ in a storage apparatus 3′.

Also in this first modification, a storing unit 61′ storing tables 24-27 is provided in the storage apparatus 3′.

The command response unit 221 in the storage managing unit 22′ sends and receives commands to and from a VM creating processing unit 211 in a VM management unit 21 through a LAN 7. For example, the command response unit 221 receives a VM creation command or a copy command from the VM creating processing unit 211 in the VM management unit 21 through the LAN 7.

Unlike the storage managing unit 22 in the above-described embodiment, the storage managing unit 22′ has no copy control calling unit 224. Instead, after the volume identifying unit 223 instructs the determination, a copy control unit (copy unit) 312′ in a storage controlling unit 31′ copies data in a source volume 51, to a destination volume 52 created by the configuration managing unit 311.

Except for the above differences, the information processing system 1′ has a configuration and functions that are similar to those of the information processing system 1 in the above described embodiment. The detailed descriptions of the similar components and functions are therefore omitted.

This second modification also provides advantages and effects similar to those of an example of the above-described embodiment.

Note that a program (storage management program) for implementing the functions as the storage managing unit 22′, and the command response unit 221, the control unit 222, and the volume identifying unit 223 in the storage managing unit 22′ in the first modification as described above, are provided in the form of programs recorded on a computer read able recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD), a Blu-ray disc, a magnetic disk, an optical disk, a magneto-optical disk, or the like. The computer then reads a program from that storage medium using a medium reader (not illustrated) and uses that program after transferring it to an internal storage apparatus or external storage apparatus or the like. Alternatively, the program may be recoded on a storage unit (storage medium), for example, a magnetic disk, an optical disk, a magneto-optical disk, or the like, and the program may be provided from the storage unit to the computer through a communication path.

Upon embodying the functions as the storage managing unit 22′, the command response unit 221, the control unit 222, and the volume identifying unit 223, the program (storage management program) stored in an internal storage apparatuses (a memory (not illustrated) in the storage apparatus 3′, in this first modification) is executed by a microprocessor of the computer (a CPU (not illustrated) in the storage apparatus 3′, in this first modification). In this case, the computer may alternatively read a program stored in a storage medium for executing it.

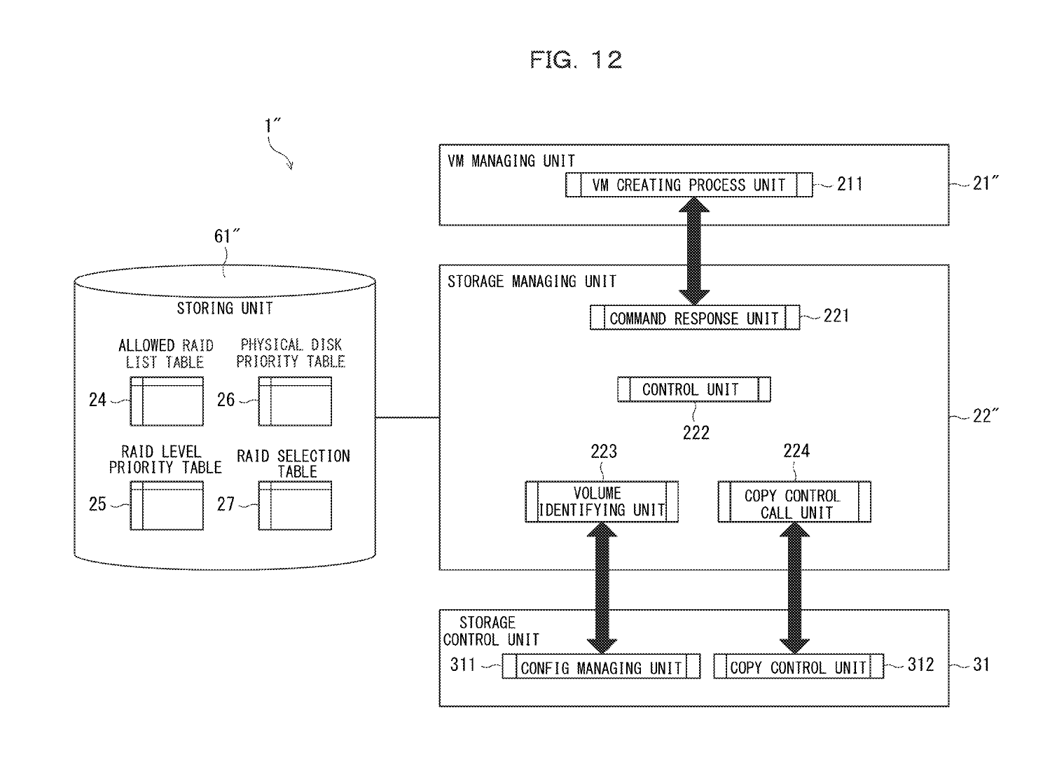

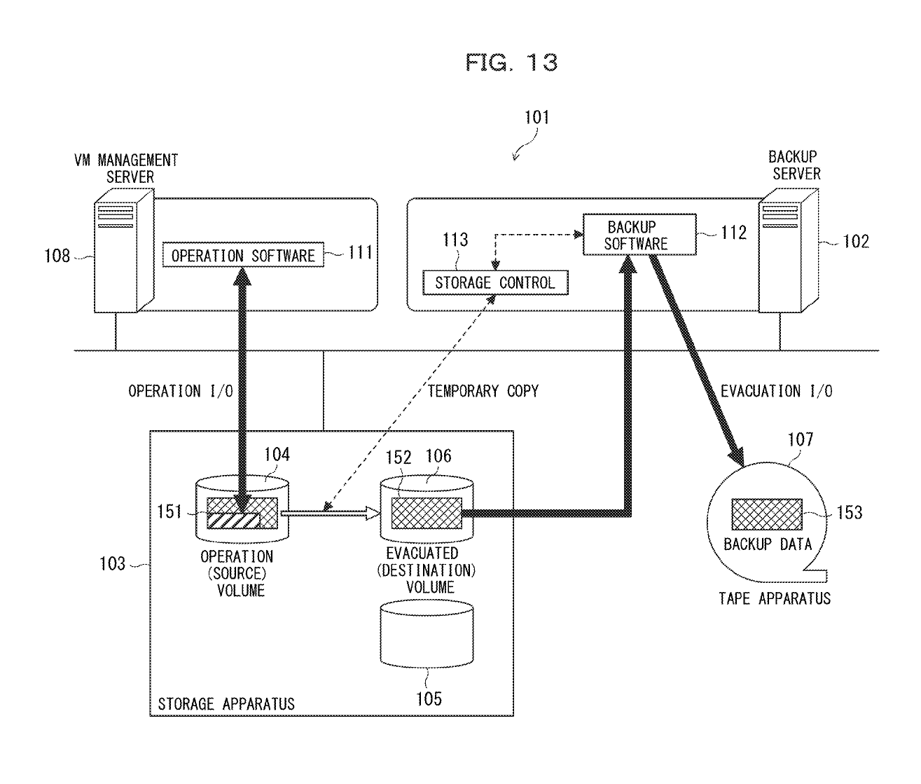

FIG. 11 is a diagram illustrating an overall configuration of an information processing system 1″ as a second modification to an embodiment, and FIG. 12 is a diagram illustrating a functional configuration of the information processing system 1″ in FIG. 11.

Unlike the VM management server 2 and the storage apparatus 3 which are separate in an example of an embodiment illustrated in FIG. 1, in this information processing system 1″, a VM management server 2″ is integrated into a storage apparatus 3″. The VM management server 2″ includes a VM management unit 21″ and a storage managing unit 22″.

The VM management unit 21″ and the storage managing unit 22″ have configurations and functions similar to those of the VM management unit 21 and the storage managing unit 22 in an example of the above-described embodiment, and their descriptions are omitted.

In this second modification, however, the storage managing unit 22″ and the storage controlling unit 31 communicate each other through an internal bus (not illustrated) in the storage apparatus 3″, rather than through a LAN 7.

Also in this second modification, a storing unit 61″ storing tables 24-27 is provided in the storage apparatus 3″

Except for the above differences, the information processing system 1″ has a configuration and functions that are similar to those of the information processing system 1 in the above described embodiment. The detailed descriptions of the similar components and functions are therefore omitted.

In addition to advantages and effects similar to those of an example of the above-described embodiment, this second modification is advantageous in that the integration of the VM management server 2″ into the storage apparatus 3″ provides a reduction in space and avoids any disadvantageous effects caused by network delays over the LAN 7.

Note that a program (storage management program) for implementing the functions as the storage managing unit 22″, and the command response unit 221, the control unit 222, the volume identifying unit 223, and the copy control calling unit 224 in the second modification as described above, are provided in the form of programs recorded on a computer read able recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD), a Blu-ray disc, a magnetic disk, an optical disk, a magneto-optical disk, or the like. The computer then reads a program from that storage medium using a medium reader (not illustrated) and uses that program after transferring it to an internal storage apparatus or external storage apparatus or the like. Alternatively, the program may be recoded on a storage unit (storage medium), for example, a magnetic disk, an optical disk, a magneto-optical disk, or the like, and the program may be provided from the storage unit to the computer through a communication path.

Upon embodying the functions as the storage managing unit 22″, and the command response unit 221, the control unit 222, the volume identifying unit 223, and the copy control calling unit 224 in the second modification, the program (storage management program) stored in an internal storage apparatuses (a memory (not illustrated) in the storage apparatus 3″, in this second modification) is executed by a microprocessor of the computer (a CPU (not illustrated) in the storage apparatus 3″, in this second modification). In this case, the computer may alternatively read a program stored in a storage medium for executing it.

In accordance with the present disclosure, a volume copy can be made in a storage apparatus, without specifying a destination volume.

All examples and conditional language recited herein are intended for the pedagogical purposes of aiding the reader in understanding the invention and the concepts contributed by the inventor to further the art, and are not to be construed limitations to such specifically recited examples and properties, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage management apparatus, comprising:
a receiving unit that receives a copy command instructing a storage apparatus to copy data in a source volume among a plurality of volumes created to the storage apparatus, to a destination volume;
a determination unit that obtains, from the storage apparatus, information on a configuration of the source volume specified in the copy command, determines a property for creating the destination volume based on the obtained information on the configuration of the source volume, and instructs the storage apparatus to create the destination volume; and
a copy instructing unit that instructs a copy of the data in the source volume, into the destination volume that is created.

2. The storage management apparatus according to claim 1, wherein the information on the configuration of the source volume is a property for creating the source volume and a redundancy of the source volume.

3. The storage management apparatus according to claim 1, wherein the information on the configuration of the source volume is a property for creating the source volume and a physical disk type of the source volume.

4. The storage management apparatus according to claim 1, wherein the determination unit specifies, when a copy type specified in the copy command is a differential copy, a redundancy group for the source volume, as a redundancy group for the destination volume to be created, and
the determination unit species, when the copy type specified in the copy command is a full copy, a redundancy group other than the redundancy group for the source volume, as a redundancy group for the destination volume to be created.

5. A storage apparatus comprising:
at least one storage device that comprises a storage region capable of storing data;
a configuration managing unit that creates a part of the storage region in the at least one storage device, as a plurality of volumes;
a receiving unit that receives, from a host apparatus, a copy command instructing a copy of data in a source volume among the created plurality of volumes, to a destination volume;
a determination unit that obtains, from the configuration managing unit, information on a configuration of the source volume specified in the copy command, determines a property for creating the destination volume based on the obtained information on the configuration of the source volume, and instructs the configuration managing unit to create the destination volume; and
a copy unit that copies the data in the source volume, into the destination volume that is created.

6. Anon-transitory computer readable storage medium having a storage management program stored therein, the storage management program causing a computer to:
receive a copy command instructing a storage apparatus to copy data in a source volume among a plurality of volumes created to the storage apparatus, to a destination volume;
obtain, from the storage apparatus, information on a configuration of the source volume specified in the copy command, determine a property for creating the destination volume based on the obtained information on the configuration of the source volume, and instruct the storage apparatus to create the destination volume; and
instruct a copy of the data in the source volume, into the destination volume that is created.

7. The non-transitory computer readable storage medium according to claim 6, wherein the information on the configuration of the source volume is a property for creating the source volume and a redundancy of the source volume.

8. The non-transitory computer readable storage medium according to claim 6, wherein the information on the configuration of the source volume is a property for creating the source volume and a physical disk type of the source volume.

9. The non-transitory computer readable storage medium according to claim 6, wherein the storage management program further causes the computer to:
specify, when a copy type specified in the copy command is a differential copy, a redundancy group for the source volume, as a redundancy group for the destination volume to be created, and
specify, when the copy type specified in the copy command is a full copy, a redundancy group other than the redundancy group for the source volume, as a redundancy group for the destination volume to be created.
